(19) United States
(12) Patent Application Publication
(10) Pub. No.: US 2025/0206104 A1
(43) Pub. Date: Jun. 26, 2025

(54) THERMAL CONDITIONING SYSTEM

(71) Applicant: VALEO SYSTEMES THERMIQUES, Le Mesnil-Saint-Denis (FR)

(72) Inventors: Moussa Nacer Bey, Le Mesnil-Saint-Denis (FR); Kamel Azzouz, Le Mesnil-Saint-Denis (FR); Julien Tissot, Le Mesnil-Saint-Denis (FR); Francois Bordes, Le Mesnil-Saint-Denis (FR)

(73) Assignee: VALEO SYSTEMES THERMIQUES, Le Mesnil-Saint-Denis (FR)

(21) Appl. No.: 18/851,606

(22) PCT Filed: Mar. 9, 2023
(86) PCT No.: PCT/EP2023/056073

§ 371 Date: Sep. 26, 2024

(30) Foreign Application Priority Data
Mar. 26, 2022 (FR) FR2202716

(51) Int. Cl. B60H 1/32; B60H 1/00

(52) U.S. Cl. CPC B60H 1/323; B60H 1/3227; B60H 1/3228; B60H 1/00385

(57) ABSTRACT

A thermal conditioning system for a motor vehicle, comprising: a refrigerant circuit comprising: a compressor, a first two-fluid exchanger, arranged on a heat transfer liquid circuit, a first expansion device, a second two-fluid exchanger, a dielectric heat transfer fluid circuit, comprising: a primary loop comprising the second two-fluid exchanger and a third exchanger thermally coupled to a first element of an electric drive train of the vehicle, a first bypass branch comprising a fourth exchanger and a fifth exchanger respectively thermally coupled to a second element and a third element of the drive train, a second bypass branch comprising a sixth exchanger configured to exchange heat with an outside air stream.

### TECHNICAL FIELD

The present invention relates to the field of thermal conditioning systems. These systems can in particular be provided on a motor vehicle. Such systems allow thermal regulation of various members of the vehicle, such as the passenger compartment or an electrical energy storage battery for example, in the case of an electrically powered vehicle. The heat exchanges are mainly managed by the compression and expansion of a refrigerant within various heat exchangers, allowing the heating or cooling of various members.

### PRIOR ART

Thermal conditioning systems often make use of a refrigerant loop and a loop for heat transfer liquid that exchanges heat with the refrigerant. Such systems are thus referred to as indirect. Patent EP2933586 B1 is one example of this. The refrigerant loop is formed so that the refrigerant gives up heat to a heat transfer liquid in a first two-fluid exchanger. The heat given up to the heat transfer liquid can then be dissipated into an air stream intended for the passenger compartment, in order to heat it. The heat transfer liquid circuit also makes it possible to cool elements of the drive train of the vehicle that dissipate heat, such as the electric drive motor of the vehicle or the power electronics controlling the electric motor. To this end, another two-fluid exchanger allows a heat exchange between the heat transfer liquid and the refrigerant in order to cool the heat transfer liquid.

In addition, the rapid charging requirements of the batteries require an increase in the cooling power available. In order for high cooling power to be available for cooling the batteries, together with satisfactory uniformity of the temperature of the batteries, it is known practice to circulate a dielectric heat transfer fluid inside the elements of the battery. In this case, an additional two-fluid exchanger is used, in order to exchange heat between the refrigerant and the dielectric heat transfer fluid. This configuration is complex and costly to implement as a large number of heat exchangers is used, particularly a large number of two-fluid heat exchangers.

There is therefore a need to provide thermal conditioning systems that are easier to incorporate and use fewer heat exchangers and simpler circuits for the circulation of the various fluids.

### SUMMARY

To this end, the present invention proposes a thermal conditioning system for an electric or hybrid motor vehicle, comprising:
a refrigerant circuit comprising a main circulation loop comprising in succession, in a direction of circulation of the refrigerant:
   a compression device,
   a first two-fluid exchanger, arranged both on the main refrigerant loop and on a heat transfer liquid circuit so as to allow a heat exchange between the refrigerant and the heat transfer liquid,
   a first expansion device,
   a second two-fluid exchanger,
a dielectric heat transfer fluid circuit, comprising:
   a primary circulation loop comprising in succession, in a direction of circulation of the dielectric heat transfer fluid:
   the second two-fluid exchanger, arranged both on the main refrigerant loop and on the primary dielectric heat transfer fluid loop so as to allow a heat exchange between the refrigerant and the dielectric heat transfer fluid,
   a third heat exchanger configured to be thermally coupled to a first element of an electric drive train of the vehicle,
   a first bypass branch connected to the primary loop in parallel with the third heat exchanger, the first bypass branch comprising a fourth heat exchanger configured to be thermally coupled to a second element of the electric drive train of the vehicle and a fifth heat exchanger configured to be thermally coupled to a third element of the electric drive train of the vehicle,
   a second bypass branch connected to the primary loop in parallel with the second two-fluid exchanger, the second bypass branch comprising a sixth heat exchanger configured to exchange heat with an air stream outside a passenger compartment of the vehicle.

This architecture makes it possible to ensure high cooling power for cooling the various elements of the drive train of the vehicle using just two two-fluid exchangers. The incorporation of the thermal conditioning circuit is thus facilitated.

The features listed in the following paragraphs can be implemented independently of one another or in any technically possible combination:

The first element of the electric drive train of the vehicle can be an electrical energy storage battery. The battery can supply the energy necessary for an electric drive motor of the vehicle.

The second element of the electric drive train of the vehicle can be an electronic control unit of an electric drive motor.

The third element of the electric drive train of the vehicle can be an electric drive motor of the vehicle.

According to one aspect of the thermal conditioning system, the heat transfer liquid circuit comprises a primary circulation loop comprising in succession, in a direction of circulation of the heat transfer liquid:
the first two-fluid exchanger, arranged both on the main refrigerant loop and on the primary heat transfer liquid circulation loop so as to allow a heat exchange between the refrigerant and the heat transfer liquid,
a seventh heat exchanger configured to exchange heat with an air stream inside the passenger compartment of the vehicle.

The heat recovered from the outside stream by the dielectric heat transfer fluid, in the sixth exchanger, can thus be transferred to the air stream inside the passenger compartment, which makes it possible to heat the passenger compartment. This energy recovery can take place even at very negative ambient temperatures, as the dielectric heat transfer fluid generally has low viscosity. The thermal conditioning system can thus heat the passenger compartment even at low ambient temperatures.

According to another aspect of the thermal conditioning system, the heat transfer liquid circuit comprises a bypass branch connected to the primary loop in parallel with the first two-fluid exchanger, the bypass branch comprising an eighth heat exchanger configured to exchange heat with an air stream outside the passenger compartment of the vehicle.

This bypass branch and the associated heat exchanger make it possible to dissipate the refrigerant condensation heat into the air, for example when the cooling of one or more elements of the drive train of the vehicle is desired.

The bypass branch of the heat transfer liquid circuit connects a first connection point positioned on the primary loop of the heat transfer liquid circuit between a first inlet/outlet of the first two-fluid exchanger and a first inlet/outlet of the eighth heat exchanger to a second connection point positioned on the primary loop of the heat transfer liquid circuit between a second inlet/outlet of the eighth heat exchanger and a second inlet/outlet of the first two-fluid exchanger.

According to one embodiment of the thermal conditioning system, the refrigerant circuit comprises a bypass branch positioned in parallel with the first expansion device and the second two-fluid exchanger, the bypass branch comprising in succession a second expansion device and a ninth heat exchanger configured to exchange heat with an air stream inside the passenger compartment of the vehicle.

This bypass branch and the associated heat exchanger make it possible to cool the passenger compartment of the vehicle.

The bypass branch of the refrigerant circuit connects a first junction point positioned on the main loop downstream of the first two-fluid exchanger and upstream of the second two-fluid exchanger to a second junction point positioned on the main loop downstream of the second two-fluid exchanger and upstream of the compression device. The bypass branch comprises a second expansion device positioned upstream of a ninth heat exchanger.

The first bypass branch of the dielectric heat transfer fluid circuit connects a first connection point positioned on the primary loop of the dielectric heat transfer fluid circuit between a first dielectric heat transfer fluid inlet/outlet of the second two-fluid exchanger and a first inlet/outlet of the third heat exchanger to a second connection point positioned on the primary loop of the dielectric heat transfer fluid circuit between a second inlet/outlet of the third heat exchanger and a second dielectric heat transfer fluid inlet/outlet of the second two-fluid exchanger.

The second bypass branch of the dielectric heat transfer fluid circuit connects a third connection point positioned on the primary loop of the dielectric heat transfer fluid circuit between the second two-fluid exchanger and the first connection point to a fourth connection point positioned on the primary loop of the dielectric heat transfer fluid circuit between the second connection point and the second two-fluid exchanger.

The sixth heat exchanger is preferably positioned upstream of the eighth heat exchanger in a direction of flow of the outside air stream.

The ninth heat exchanger is positioned upstream of the seventh heat exchanger in a direction of flow of the inside air stream.

According to one aspect of the thermal conditioning system, the primary loop of the dielectric heat transfer fluid circuit comprises a first circulation pump.

The first circulation pump is configured to circulate the dielectric heat transfer fluid from the second two-fluid exchanger to the third heat exchanger.

The first circulation pump is positioned between the fourth connection point of the dielectric heat transfer fluid circuit and the second two-fluid exchanger.

According to another aspect of the thermal conditioning system, the primary loop of the heat transfer liquid circuit comprises a second circulation pump.

The second circulation pump is configured to circulate the heat transfer liquid from the first two-fluid exchanger to the seventh heat exchanger.

According to one exemplary embodiment of the thermal conditioning system, the primary loop of the dielectric heat transfer fluid circuit comprises a third circulation pump configured to take the dielectric heat transfer fluid from the third heat exchanger to the sixth heat exchanger without passing through the second two-fluid exchanger.

According to one embodiment of the thermal conditioning system, the main refrigerant loop comprises an internal heat exchanger comprising a first heat exchange section positioned downstream of the first two-fluid exchanger and upstream of the second two-fluid exchanger, and a second heat exchange section positioned downstream of the second two-fluid exchanger and upstream of the compression device, the internal heat exchanger being configured to allow a heat exchange between the refrigerant in the first heat exchange section and the refrigerant in the second heat exchange section.

According to one exemplary embodiment of the thermal conditioning system, the primary heat transfer liquid loop comprises an electric heating device configured to selectively heat the heat transfer liquid.

The electric heating device can be activated selectively so as to accelerate the temperature increase of the heat transfer liquid.

According to one exemplary embodiment of the thermal conditioning system, the eighth heat exchanger is positioned upstream of the sixth heat exchanger in a direction of flow of the outside air stream. The eighth heat exchanger can then be used as a hot plate for de-icing, in particular through the use of the electric heating device to heat the heat transfer liquid.

According to one embodiment of the thermal conditioning system, the dielectric heat transfer fluid circuit comprises a first three-way valve positioned both on the primary loop and on the first bypass branch.

A single component thus makes it possible to adjust the respective flow in two different parts of the dielectric heat transfer fluid circuit, namely the primary loop comprising the third heat exchanger, and the first bypass branch comprising the fourth and fifth heat exchangers.

The first three-way valve is a proportional valve.

The dielectric heat transfer fluid circuit can comprise a second three-way valve positioned both on the primary loop and on the second bypass branch.

A single component thus makes it possible to adjust the respective flow in two different parts of the dielectric heat transfer fluid circuit, namely the primary loop and the second bypass branch.

The second three-way valve is preferably a proportional valve.

According to one exemplary embodiment of the thermal conditioning system, the heat transfer liquid circuit comprises a third three-way valve positioned both on the primary loop and on the bypass branch.

A single component thus makes it possible to adjust the respective flow in two different parts of the heat transfer liquid circuit, namely the primary loop and the bypass branch.

The third three-way valve is preferably a proportional valve.

According to one embodiment of the thermal conditioning system, the main loop of the refrigerant circuit comprises a refrigerant accumulation device positioned downstream of the second two-fluid exchanger and upstream of the compression device.

In one exemplary embodiment, the refrigerant accumulation device is positioned upstream of the second heat exchange section of the internal exchanger.

The invention also relates to a method of operation of a thermal conditioning system as described above, in a passenger compartment heating mode, wherein:
the refrigerant circulates in the compression device where it becomes high-pressure refrigerant, and circulates in succession in the first two-fluid exchanger where it gives up heat to the heat transfer liquid, in the first expansion device where it becomes low-pressure refrigerant, and in the second two-fluid exchanger where it absorbs heat from the dielectric heat transfer fluid, and returns to the compression device,
the dielectric heat transfer fluid circulates in the second two-fluid exchanger where it gives up heat to the refrigerant, and splits into:
   a first flow circulating in the primary loop and
   a second flow circulating in the second bypass branch, the second flow circulating in the sixth heat exchanger where it absorbs heat from the outside air stream, the first flow splitting into a third flow circulating in the third heat exchanger where it absorbs heat, and a fourth flow circulating in succession in the fourth heat exchanger where it absorbs heat, and in the fifth heat exchanger where it absorbs heat,
the third flow and the fourth flow coming back together with each other and then coming back together with the second flow,
the heat transfer liquid circulates in the first two-fluid exchanger where it receives heat from the refrigerant, and circulates in the seventh heat exchanger where it gives up heat to the inside air stream.

This operating mode makes it possible to heat the air inside the passenger compartment, by absorbing heat from the various elements of the electric drive train of the vehicle, and from the outside air stream Fe. As the dielectric heat transfer fluid retains its low viscosity at low temperatures, the circulation pump consumes little energy and the thermal efficiency is thus improved at low ambient temperatures.

The invention also relates to a method of operation of a thermal conditioning system as described above, in a drive train cooling mode, wherein:
the refrigerant circulates in the compression device where it becomes high-pressure refrigerant, and circulates in succession in the first two-fluid exchanger where it gives up heat to the heat transfer liquid, in the first expansion device where it becomes low-pressure refrigerant, and in the second two-fluid exchanger where it absorbs heat from the dielectric heat transfer fluid, and returns to the compression device,
the dielectric heat transfer fluid circulates in the second two-fluid exchanger where it gives up heat to the refrigerant, and splits into a first flow circulating in the third heat exchanger where it absorbs heat, and a second flow circulating in succession in the fourth heat exchanger where it absorbs heat and in the fifth heat exchanger where it absorbs heat, the second flow coming back together with the first flow,
the heat transfer liquid circulates in the first two-fluid exchanger where it receives heat from the refrigerant, and circulates in the eighth heat exchanger where it gives up heat to the outside air stream.

This operating mode makes it possible to cool the first element, the second element, and the third element of the electric drive train of the vehicle. The heat given up by the refrigerant to the heat transfer liquid is dissipated into the outside air stream.

The invention also relates to a method of operation of a thermal conditioning system as described above, in a drive train and passenger compartment cooling mode, wherein:
the refrigerant circulates in the compression device where it becomes high-pressure refrigerant, and circulates in the first two-fluid heat exchanger where it gives up heat to the heat transfer liquid, and then splits into:
   a first refrigerant flow circulating in the first expansion device where it becomes low-pressure refrigerant, and in the second two-fluid exchanger where it absorbs heat from the dielectric heat transfer fluid,
   a second refrigerant flow circulating in the second expansion device where it becomes low-pressure refrigerant, and in the ninth heat exchanger where it absorbs heat from the inside air stream,
the first refrigerant flow and the second refrigerant flow coming back together before returning to the compression device,
the dielectric heat transfer fluid circulates in the second two-fluid exchanger where it gives up heat to the refrigerant, and splits into a first flow circulating in the third heat exchanger where it absorbs heat, and a second flow circulating in succession in the fourth heat exchanger where it absorbs heat and in the fifth heat exchanger where it absorbs heat, the second flow coming back together with the first flow,
the heat transfer liquid circulates in the first two-fluid exchanger where it receives heat from the refrigerant, and circulates in the eighth heat exchanger where it gives up heat to the outside air stream.

This operating mode makes it possible to cool the first element, the second element, and the third element of the electric drive train of the vehicle. The heat given up by the refrigerant to the heat transfer liquid is dissipated into the outside air stream.

### BRIEF DESCRIPTION OF THE DRAWINGS

Further features, details and advantages will become apparent on reading the detailed description below, and on studying the appended drawings, in which:

FIG. 1 is a schematic view of a thermal conditioning system according to one embodiment of the invention,

FIG. 2 is a schematic view of a thermal conditioning system according to a variant of the embodiment of FIG. 1,

FIG. 3 shows a schematic view of the thermal conditioning system of FIG. 2 according to a first operating mode referred to as passenger compartment heating mode,

FIG. 4 shows a schematic view of the thermal conditioning system of FIG. 2 according to a second operating mode referred to as drive train cooling mode,

FIG. 5 shows a schematic view of the thermal conditioning system of FIG. 2 according to a third operating mode referred to as drive train and passenger compartment cooling mode.

### DESCRIPTION OF THE EMBODIMENTS

In order to make the figures easier to read, the various elements are not necessarily shown to scale. In these figures, identical elements bear the same reference signs. Some elements or parameters can be given ordinal numbers, in other words designated for example first element or second element, or first parameter and second parameter, etc. The purpose of this ordinal numbering is to make a distinction between elements or parameters that are similar but not identical. This ordinal numbering does not imply any priority of one element, or parameter, over another. The terms ‘first’, ‘second’, ‘third’, etc. can thus be interchanged.

Likewise, the terms primary/secondary are used in an ordinal manner and do not imply any priority of one element over another.

In the description below, the expression “a first element upstream of a second element” means that the first element is placed before the second element with respect to the direction of circulation, or travel, of a fluid. Similarly, the expression “a first element downstream of a second element” means that the first element is placed after the second element with respect to the direction of circulation, or travel, of the fluid concerned. In the case of the refrigerant circuit, the expression “a first element is upstream of a second element” means that the refrigerant travels in succession through the first element and then the second element, without passing through the compression device. In other words, the refrigerant leaves the compression device, optionally passes through one or more elements, and then passes through the first element, then the second element, then returns to the compression device, optionally having passed through further elements.

The expression “a second element is placed between a first element and a third element” means that the shortest path for travelling from the first element to the third element passes through the second element.

When it is specified that a sub-system comprises a given element, this does not rule out the presence of other elements in this sub-system.

Each of the expansion devices used can be an electronic expansion valve, a thermostatic expansion device, or a calibrated orifice. In the case of an electronic expansion valve, the flow area allowing the refrigerant to pass through can be adjusted continuously between a closed position and a fully open position. To this end, the electronic controller controls an electric motor that moves a movable shut-off device controlling the flow area available to the refrigerant.

The thermal conditioning system 100 that will be described can be provided on a motor vehicle. An electronic control unit, not shown, receives information from various sensors measuring in particular the characteristics of the refrigerant. The electronic control unit also receives setpoints issued by the occupants of the vehicle, such as the desired temperature inside the passenger compartment for example. The electronic control unit implements control laws for operating the various actuators, in order to control the thermal conditioning system 100 so as to achieve the setpoints received. A compression device 15 makes it possible to circulate a refrigerant in a closed refrigerant circulation circuit. The compression device 15 can be an electric compressor, that is a compressor with moving parts driven by an electric motor. The compression device 15 comprises a suction side for the low-pressure refrigerant, also referred to as the inlet 15a of the compression device, and a discharge side for the high-pressure refrigerant, also referred to as the outlet 15b of the compression device 15. The internal moving parts of the compressor 15 take the refrigerant from low pressure on the inlet 15a side to high pressure on the outlet 15b side. After expansion in one or more expansion members, the refrigerant returns to the inlet 15a of the compressor 15 and begins a new thermodynamic cycle.

Each junction point allows the refrigerant to enter one or other of the circuit portions that meet at this junction point. The refrigerant is distributed between the circuit portions meeting at a junction point by adjusting the degree of opening of the expansion devices positioned on each of the branches connected to this point. In other words, each junction point is a means for redirecting the refrigerant arriving at this junction point.

The refrigerant used by the refrigerant circuit 11 is in this case a chemical fluid such as R1234yf. Other refrigerants could be used, such as R134a or R290 for example.

Each connection point of the heat transfer liquid circuit allows the heat transfer liquid to enter one or the other of the heat transfer liquid circuit portions that meet at this connection point. Each junction point of the heat transfer liquid circuit is a means for redirecting the heat transfer liquid arriving at this connection point. Likewise, each connection point of the dielectric heat transfer fluid circuit allows the dielectric heat transfer fluid to enter one or the other of the dielectric heat transfer fluid circuit portions that meet at this connection point. Each junction point of the dielectric heat transfer fluid circuit is a means for redirecting the dielectric heat transfer fluid arriving at this connection point.

Inside air stream Fi is given to mean an air stream intended for the passenger compartment of the motor vehicle. This inside air stream can circulate in a heating, ventilation and air conditioning (HVAC) installation. This installation is not shown in the various figures. A motor-fan unit, not shown, can be activated in order to increase the flow of the inside air stream Fi if necessary. Outside air stream Fe is given to mean an air stream not intended for the passenger compartment of the vehicle. In other words, this air stream remains outside the vehicle. Another motor-fan unit, not shown, can be activated in order to increase the flow of the outside air stream Fe if necessary.

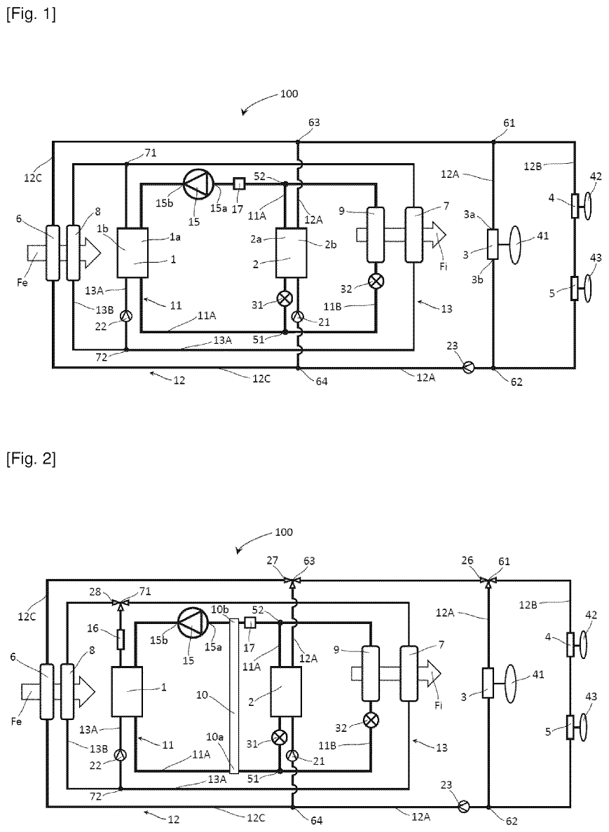

FIG. 1 shows a first embodiment of a thermal conditioning system 100 for an electric or hybrid motor vehicle, comprising:
a refrigerant circuit 11 comprising a main circulation loop 11A comprising in succession, in a direction of circulation of the refrigerant:
   a compression device 15,
   a first two-fluid exchanger 1, arranged both on the main refrigerant loop 11A and on a heat transfer liquid circuit 13 so as to allow a heat exchange between the refrigerant and the heat transfer liquid,
   a first expansion device 31,
   a second two-fluid exchanger 2,
a dielectric heat transfer fluid circuit 12, comprising:
   a primary circulation loop 12A comprising in succession, in a direction of circulation of the dielectric heat transfer fluid:
   the second two-fluid exchanger 2, arranged both on the main refrigerant loop 11A and on the primary dielectric heat transfer fluid loop 12A so as to allow a heat exchange between the refrigerant and the dielectric heat transfer fluid,
   a third heat exchanger 3 configured to be thermally coupled to a first element 41 of an electric drive train of the vehicle,
   a first bypass branch 12B connected to the primary loop 12A in parallel with the third heat exchanger 3, the first bypass branch 12B comprising a fourth heat exchanger 4 configured to be thermally coupled to a second element 42 of the electric drive train of the vehicle and a fifth heat exchanger 5 configured to be thermally coupled to a third element 43 of the electric drive train of the vehicle,
   a second bypass branch 12C connected to the primary loop 12A in parallel with the second two-fluid exchanger 2, the second bypass branch 12C comprising a sixth heat exchanger 6 configured to exchange heat with an air stream Fe outside a passenger compartment of the vehicle.

This architecture makes it possible to ensure high cooling power for cooling the various elements of the drive train of the vehicle using just two two-fluid exchangers. The incorporation of the thermal conditioning circuit is thus facilitated.

The first element 41 of the electric drive train of the vehicle can be an electrical energy storage battery. The battery can supply the energy necessary for an electric drive motor of the vehicle. The third heat exchanger 3 can be formed by the electrical energy storage battery. In other words, the cells of the battery are in direct contact with the dielectric heat transfer fluid. The dielectric heat transfer fluid thus exchanges heat with the elements of the battery to be cooled.

The second element 42 of the electric drive train of the vehicle can be an electronic control unit of an electric drive motor. The fourth heat exchanger 4 can be formed by the electronic control unit of the electric motor, that is, the electronic elements that dissipate heat are in direct contact with the dielectric heat transfer fluid. The dielectric heat transfer fluid circulates inside the housing of the electronic control unit of the electric motor.

The third element 43 of the electric drive train of the vehicle can be an electric drive motor of the vehicle. The fifth heat exchanger 5 can be formed by the electric motor, that is, the components of the motor that dissipate heat are in direct contact with the dielectric heat transfer fluid.

The dielectric heat transfer fluid is electrically insulating. The dielectric fluid can thus be in direct contact with live elements. The dielectric heat transfer fluid can be two-phase, that is, it can comprise a mixture of liquid and vapor.

The first two-fluid exchanger 1 makes it possible to at least partially condense the high-temperature, high-pressure refrigerant leaving the compression device 15. The second two-fluid exchanger 2 can make it possible to at least partially evaporate the low-pressure refrigerant leaving the first expansion device 31.

The refrigerant circuit 11 forms a closed circuit configured to circulate a refrigerant flow. The dielectric heat transfer fluid circuit 12 forms a closed circuit configured to circulate a dielectric heat transfer fluid flow. The heat transfer liquid circuit 13 forms a closed circuit configured to circulate a heat transfer liquid flow. In its nominal operating state, that is, without any faults causing a leak, each of the circuits is sealed. The refrigerant circuit 11, the dielectric heat transfer fluid circuit 12 and the heat transfer liquid circuit 13 are unconnected. In other words, the refrigerant, the dielectric heat transfer fluid and the heat transfer liquid cannot mix when the thermal conditioning system is in a nominal operating state.

The refrigerant and the heat transfer liquid can exchange heat in the first two-fluid exchanger 1. The heat transfer liquid circulating in one part of the first two-fluid exchanger 1 is for example a mixture of water and glycol. The first two-fluid exchanger 1 comprises a first heat exchange section 1a through which the refrigerant travels and a second heat exchange section 1b through which the heat transfer liquid travels. Heat is exchanged between the first heat exchange section 1a and the second heat exchange section 1b of the first two-fluid exchanger 1.

Likewise, the refrigerant and the dielectric heat transfer fluid can exchange heat in the second two-fluid exchanger 2. The second two-fluid exchanger 2 comprises a first heat exchange section 2a through which the refrigerant travels and a second heat exchange section 2b through which the dielectric heat transfer fluid travels. Heat is exchanged between the first heat exchange section 2a and the second heat exchange section 2b of the second two-fluid exchanger 2.

Each two-fluid exchanger 1, 2 allows a heat exchange between two fluids each circulating in a closed circuit. The first two-fluid exchanger 1 is separate from the second two-fluid exchanger 2. In other words, the first two-fluid exchanger 1 and the second two-fluid exchanger 2 do not have any common portions.

The heat transfer liquid circuit 13 comprises a primary circulation loop 13A comprising in succession, in a direction of circulation of the heat transfer liquid:
the first two-fluid exchanger 1, arranged both on the main refrigerant loop 11A and on the primary heat transfer liquid circulation loop 13A so as to allow a heat exchange between the refrigerant and the heat transfer liquid,
a seventh heat exchanger 7 configured to exchange heat with an air stream Fi inside the passenger compartment of the vehicle.

The heat transferred from the refrigerant to the heat transfer liquid in the first two-fluid exchanger 1 can thus be dissipated into the inside air stream Fi and thus heat the passenger compartment. In addition, the heat recovered from the outside stream Fe by the dielectric heat transfer fluid, in the sixth exchanger 6, can thus be transferred to the air stream Fi inside the passenger compartment, which also makes it possible to heat the passenger compartment. This energy recovery can take place even at very negative ambient temperatures, as the dielectric heat transfer fluid generally has low viscosity. The thermal conditioning system can thus heat the passenger compartment even at low ambient temperatures.

The heat transfer liquid circuit 13 comprises a bypass branch 13B connected to the primary loop 13A in parallel with the first two-fluid exchanger 1, the bypass branch 13B comprising an eighth heat exchanger 8 configured to exchange heat with an air stream Fe outside the passenger compartment of the vehicle. This bypass branch 13B and the associated heat exchanger 8 make it possible to dissipate the refrigerant condensation heat into the outside air stream Fe, for example when the cooling of one or more elements of the drive train of the vehicle is desired.

The bypass branch 13B of the heat transfer liquid circuit 13 connects a first connection point 71 positioned on the primary loop 13A of the heat transfer liquid circuit 13 between a first inlet/outlet of the first two-fluid exchanger 1 and a first inlet/outlet of the eighth heat exchanger 8 to a second connection point 72 positioned on the primary loop 13A of the heat transfer liquid circuit 13 between a second inlet/outlet of the eighth heat exchanger 8 and a second inlet/outlet of the first two-fluid exchanger 1.

The refrigerant circuit 11 comprises a bypass branch 11B positioned in parallel with the first expansion device 31 and the second two-fluid exchanger 2, the bypass branch 11B comprising in succession a second expansion device 32 and a ninth heat exchanger 9 configured to exchange heat with an air stream Fi inside the passenger compartment of the vehicle. This bypass branch 11B and the associated heat exchanger 9 make it possible to cool the passenger compartment of the vehicle by evaporating low-pressure refrigerant.

The bypass branch 11B of the refrigerant circuit 11 connects a first junction point 51 positioned on the main loop 11A downstream of the first two-fluid exchanger 1 and upstream of the second two-fluid exchanger 2 to a second junction point 52 positioned on the main loop 11A downstream of the second two-fluid exchanger 2 and upstream of the compression device 15. The bypass branch 11B comprises a second expansion device 32 positioned upstream of a ninth heat exchanger 9.

The first bypass branch 12B of the dielectric heat transfer fluid circuit 12 connects a first connection point 61 positioned on the primary loop 12A of the dielectric heat transfer fluid circuit 12 between a first dielectric heat transfer fluid inlet/outlet of the second two-fluid exchanger 2 and a first inlet/outlet 3a of the third heat exchanger 3 to a second connection point 62 positioned on the primary loop 12A of the dielectric heat transfer fluid circuit 12 between a second inlet/outlet 3b of the third heat exchanger 3 and a second dielectric heat transfer fluid inlet/outlet of the second two-fluid exchanger 2.

The second bypass branch 12C of the dielectric heat transfer fluid circuit 12 connects a third connection point 63 positioned on the primary loop 12A of the dielectric heat transfer fluid circuit 12 between the second two-fluid exchanger 2 and the first connection point 61 to a fourth connection point 64 positioned on the primary loop 12A of the dielectric heat transfer fluid circuit 12 between the second connection point 62 and the second two-fluid exchanger 2.

More specifically, the third connection point 63 is positioned on the primary loop 12A between the first dielectric heat transfer fluid inlet/outlet of the second two-fluid exchanger 2 and the first connection point 61. The fourth connection point 64 is positioned on the primary loop 12A between the second connection point 62 and the second dielectric heat transfer fluid inlet/outlet of the second two-fluid exchanger 2.

The sixth heat exchanger 6 is positioned upstream of the eighth heat exchanger 8 in a direction of flow of the outside air stream Fe. The ninth heat exchanger 9 is positioned upstream of the seventh heat exchanger 7 in a direction of flow of the inside air stream Fi.

The primary loop 12A of the dielectric heat transfer fluid circuit 12 comprises a first circulation pump 21. The first circulation pump 21 is configured to circulate the dielectric heat transfer fluid from the second two-fluid exchanger 2 to the third heat exchanger 3. The first circulation pump 21 is positioned between the fourth connection point 64 of the dielectric heat transfer fluid circuit 12 and the second two-fluid exchanger 2.

According to one operating mode, the dielectric heat transfer fluid leaving the first circulation pump 21 circulates in the two-fluid exchanger 2 and then splits into a flow that circulates in the third heat exchanger 3 and a complementary flow that circulates in succession in the fourth heat exchanger 4 and the fifth heat exchanger 5, the two flows coming back together before returning to the inlet of the first circulation pump 21.

According to one operating mode, the dielectric heat transfer fluid leaving the first circulation pump 21 circulates in the two-fluid exchanger 2 and then splits into a flow that circulates to the third heat exchanger 3 as well as to the fourth heat exchanger 4 and the fifth heat exchanger 5, and a complementary flow that circulates in the second bypass branch 12C to the sixth heat exchanger 6, the two flows coming back together before returning to the inlet of the first circulation pump 21.

The primary loop 13A of the heat transfer liquid circuit 13 comprises a second circulation pump 22. The second circulation pump 22 is configured to circulate the heat transfer liquid from the first two-fluid exchanger 1 to the seventh heat exchanger 7. The second circulation pump 22 is positioned here between the second connection point 72 of the heat transfer liquid circuit 13 and the first two-fluid exchanger 1.

According to the example shown, the primary loop 12A of the dielectric heat transfer fluid circuit 12 comprises a third circulation pump 23 configured to take the dielectric heat transfer fluid from the third heat exchanger 3 to the sixth heat exchanger 6 without passing through the second two-fluid exchanger 2. The third circulation pump 23 is positioned between the fourth connection point 64 of the dielectric heat transfer fluid circuit 12 and the second connection point 62 of the dielectric heat transfer fluid circuit 12.

FIG. 2 shows a variant of the thermal conditioning system 100 comprising an internal heat exchanger. The main refrigerant loop 11A comprises an internal heat exchanger 10 comprising a first heat exchange section 10a positioned downstream of the first two-fluid exchanger 1 and upstream of the second two-fluid exchanger 2, and a second heat exchange section 10b positioned downstream of the second two-fluid exchanger 2 and upstream of the compression device 15, the internal heat exchanger 10 being configured to allow a heat exchange between the refrigerant in the first heat exchange section 10a and the refrigerant in the second heat exchange section 10b.

According to this variant of the thermal conditioning system 100, the primary heat transfer liquid loop 13A comprises an electric heating device 16 configured to selectively heat the heat transfer liquid. The electric heating device 16 can be activated selectively by the electronic control unit of the thermal conditioning system. The electric heating device 16 thus makes it possible to accelerate the temperature increase of the heat transfer liquid.

According to the exemplary embodiment illustrated in FIGS. 2 to 5, the dielectric heat transfer fluid circuit 12 comprises a first three-way valve 26 positioned both on the primary loop 12A and on the first bypass branch 12B. A single component thus makes it possible to adjust the respective flow in the two different parts of the dielectric heat transfer fluid circuit 12, namely the primary loop 12A comprising the third heat exchanger 3 and the first bypass branch 12B comprising the fourth and fifth heat exchangers 4, 5.

The first three-way valve 26 is for example a proportional valve. The first three-way valve 26 is thus configured to allow continuous distribution of the flow that enters through a first inlet/outlet, and a flow leaving through a second inlet/outlet and a flow leaving through a third inlet/outlet. The flow leaving through the second inlet/outlet can vary continuously between zero flow and a flow equal to the flow entering through the first inlet/outlet. The flow leaving through the third inlet/outlet is equal to the flow entering through the first inlet/outlet minus the flow leaving through the second inlet/outlet.

The first connection point 61 of the dielectric heat transfer fluid circuit 12 forms part of the first three-way valve 26. Two of the three inlets/outlets of the first three-way valve 26 form part of the primary loop 12A and the last inlet/outlet forms part of the first bypass branch 12B.

The dielectric heat transfer fluid circuit 12 here comprises a second three-way valve 27 positioned both on the primary loop 12A and on the second bypass branch 12C. The second three-way valve 27 is preferably a proportional valve. A single valve thus makes it possible to adjust the respective flow in two different parts of the dielectric heat transfer fluid circuit 12, namely the primary loop 12A and the second bypass branch 12C. The third connection point 63 of the dielectric heat transfer fluid circuit 12 forms part of the second three-way valve 27.

The heat transfer liquid circuit 13 comprises a third three-way valve 28 positioned both on the primary loop 13A and on the bypass branch 13B. A single valve thus makes it possible to adjust the respective flow in two different parts of the heat transfer liquid circuit 13, namely the primary loop 13A and the bypass branch 13B. The third three-way valve 28 is preferably a proportional valve. The first connection point 71 of the heat transfer liquid circuit 13 forms part of the third three-way valve 28.

According to variants not shown, the heat transfer liquid circuit 13 can comprise two-way valves instead of the third three-way valve 28. Likewise, the dielectric heat transfer fluid 12 can comprise two-way valves instead of the first three-way valve 26 and the second three-way valve 27. According to another variant, the eighth heat exchanger 8 is positioned upstream of the sixth heat exchanger 6 in the direction of flow of the outside air stream Fe. The eighth heat exchanger 8 can then be used as a hot plate for de-icing, in particular through the use of the electric heating device 16 to heat the heat transfer liquid.

The main loop 11A of the refrigerant circuit 11 comprises a refrigerant accumulation device 17 positioned downstream of the second two-fluid exchanger 2 and upstream of the compression device 15.

When the thermal conditioning system comprises an internal heat exchanger, the refrigerant accumulation device 17 is positioned upstream of the second heat exchange section 10b of the internal exchanger 10. The refrigerant accumulation device 17 is thus positioned downstream of the second junction point 52 and upstream of the second heat exchange section 10b of the internal exchanger 10.

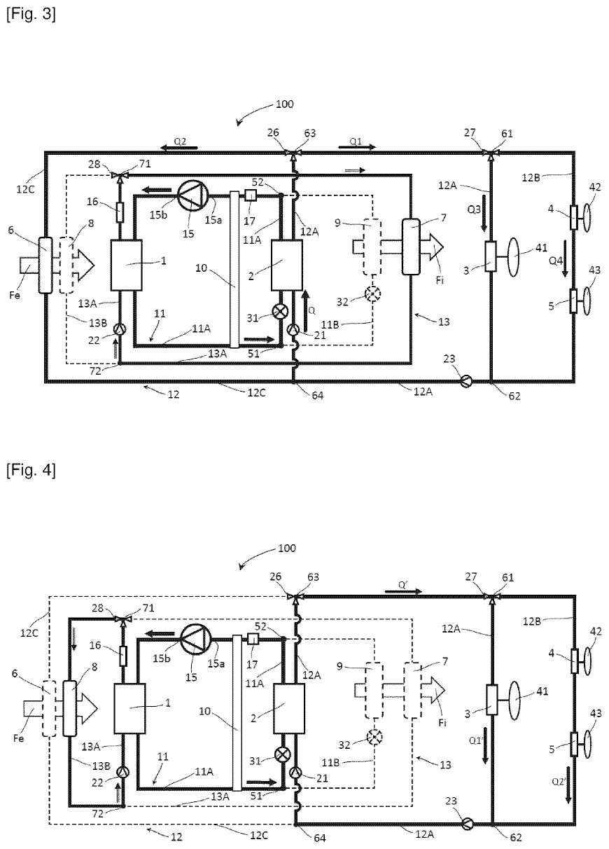

FIG. 3 illustrates a method of operation of a thermal conditioning system 100 as described above, in a passenger compartment heating mode. In this operating mode:
the refrigerant circulates in the compression device 15 where it becomes high-pressure refrigerant, and circulates in succession in the first two-fluid exchanger 1 where it gives up heat to the heat transfer liquid, in the first expansion device 31 where it becomes low-pressure refrigerant, and in the second two-fluid exchanger 2 where it absorbs heat from the dielectric heat transfer fluid, and returns to the compression device 15,
the dielectric heat transfer fluid circulates in the second two-fluid exchanger 2 where it gives up heat to the refrigerant, and splits into:
   a first flow Q1 circulating in the primary loop 12A and
   a second flow Q2 circulating in the second bypass branch 12C, the second flow Q2 circulating in the sixth heat exchanger 6 where it absorbs heat from the outside air stream Fe,
the first flow Q1 splits into a third flow Q3 circulating in the third heat exchanger 3 where it absorbs heat, and a fourth flow Q4 circulating in succession in the fourth heat exchanger 4 where it absorbs heat, and in the fifth heat exchanger 5 where it absorbs heat,
the third flow Q3 and the fourth flow Q4 come back together with each other and then come back together with the second flow Q2.
the heat transfer liquid circulates in the first two-fluid exchanger 1 where it receives heat from the refrigerant, and circulates in the seventh heat exchanger 7 where it gives up heat to the inside air stream Fi.

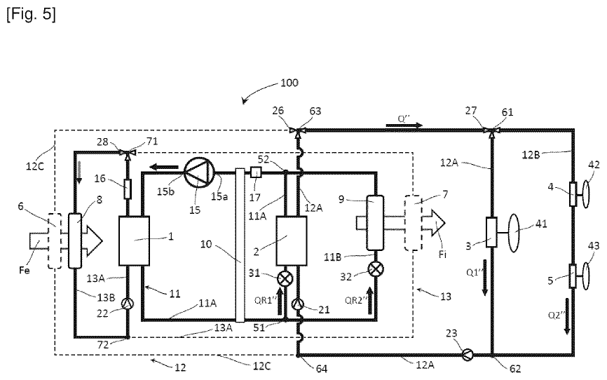

In FIG. 3, and in FIGS. 4 and 5, the circuit portions through which a fluid travels are shown in solid thick lines, and the circuit portions through which no fluid travels are shown in dashed thin lines.

In this operating mode, a flow of high-temperature, high-pressure refrigerant condenses in the first two-fluid exchanger 1. The condensation heat is thus transferred to the heat transfer liquid. The heat transfer liquid circulates in the seventh heat exchanger 7. The air stream Fi inside the passenger compartment is thus heated. The condensed refrigerant is expanded in the first expansion device 31 and evaporated in the second two-fluid exchanger 2, then passes through the accumulation device 17 and returns to the inlet 15a of the compressor 15. The heat necessary to evaporate the refrigerant is drawn from the dielectric heat transfer fluid. Part of the dielectric heat transfer fluid, that is, the third flow Q3, receives the heat released by the operation of the battery in the third heat exchanger 3. Likewise, part of the dielectric heat transfer fluid, that is, the fourth flow Q4, receives the heat released by the electronic control unit 42 in the fourth heat exchanger 4, and also receives the heat released by the electric motor 43 in the fifth heat exchanger 5. The second flow Q2 of dielectric heat transfer fluid receives heat from the outside air flow Fe in the sixth heat exchanger 6. Controlling the total flow Q of dielectric heat transfer fluid and the distribution of the total flow Q between the first flow Q1 and the second flow Q2 makes it possible to control the amount of heat recovered from the different members of the drive train and the amount of heat extracted from the outside air. This distribution is controlled by the first three-way valve 26. The flow is controlled by the circulation pumps. This operating mode offers satisfactory efficiency even at temperatures below 0° C. due to the low viscosity of the dielectric heat transfer fluid.

FIG. 4 illustrates a method of operation of a thermal conditioning system 100 as described above, in a drive train cooling mode.

In this operating mode:
the refrigerant circulates in the compression device 15 where it becomes high-pressure refrigerant, and circulates in succession in the first two-fluid exchanger 1 where it gives up heat to the heat transfer liquid, in the first expansion device 31 where it becomes low-pressure refrigerant, and in the second two-fluid exchanger 2 where it absorbs heat from the dielectric heat transfer fluid, and returns to the compression device 15,
the dielectric heat transfer fluid circulates in the second two-fluid exchanger 2 where it gives up heat to the refrigerant, and splits into a first flow Q1′ circulating in the third heat exchanger 3 where it absorbs heat, and a second flow Q2′ circulating in succession in the fourth heat exchanger 4 where it absorbs heat and in the fifth heat exchanger 5 where it absorbs heat, the second flow Q2′ coming back together with the first flow Q1′,
the heat transfer liquid circulates in the first two-fluid exchanger 1 where it receives heat from the refrigerant, and circulates in the eighth heat exchanger 8 where it gives up heat to the outside air stream Fe.

In this operating mode, a flow of high-temperature, high-pressure refrigerant condenses in the first two-fluid exchanger 1. The condensation heat is thus transferred to the heat transfer liquid. The heat transfer liquid circulates in the eighth heat exchanger 8 and dissipates this heat into the outside air stream Fe. The condensed refrigerant is expanded in the first expansion device 31 and evaporated in the second two-fluid exchanger 2, then passes through the accumulation device 17 and returns to the inlet 15a of the compressor 15. The heat necessary to evaporate the refrigerant is drawn from the dielectric heat transfer fluid, which is thus cooled. Part of the dielectric heat transfer fluid, that is, the first flow Q1′, absorbs heat from the battery in the third heat exchanger 3, which cools said battery. Likewise, part of the dielectric heat transfer fluid, that is, the second flow Q2′, absorbs heat from the electronic control unit 42 in the fourth heat exchanger 4, and also absorbs heat from the electric motor 43 in the fifth heat exchanger 5. The first dielectric heat transfer fluid flow Q1′, circulating in the primary loop 12A, and the second flow Q2′, circulating in the bypass branch 12B, come back together at the second connection point 62. Downstream of the second connection point 62, the total flow Q′ of dielectric heat transfer fluid passes in succession through the third pump 23 and the second pump 21.

The electronic control unit 42 and the electric motor 43 are thus cooled. Controlling the total flow Q′ of dielectric heat transfer fluid and controlling the distribution between the first flow Q1′ and the second flow Q2′ makes it possible to adjust the amount of heat drawn from the different members of the drive train, and thus the cooling of said members. The distribution between the first flow Q1′ and the second flow Q2′ is carried out by the second three-way valve 27. The total flow is controlled by the circulation pumps 21 and 23. The first three-way valve 26 prevents the circulation of dielectric heat transfer fluid in the second bypass branch 12C. The third three-way valve 28 prevents the circulation of heat transfer liquid in the portion of the primary loop 13A comprising the seventh heat exchanger 7. The second expansion device 32 is in the closed position, so that all of the flow of refrigerant circulates in the main loop 11A and the refrigerant does not travel through the ninth heat exchanger 9.

FIG. 5 illustrates a method of operation of a thermal conditioning system 100 as described above, in a drive train and passenger compartment cooling mode. In this operating mode:
the refrigerant circulates in the compression device 15 where it becomes high-pressure refrigerant, and circulates in the first two-fluid heat exchanger 1 where it gives up heat to the heat transfer liquid, and then splits into:
   a first refrigerant flow QR1″ circulating in the first expansion device 31 where it becomes low-pressure refrigerant and in the second two-fluid exchanger 2 where it absorbs heat from the dielectric heat transfer fluid,
   a second refrigerant flow QR2″ circulating in the second expansion device 32 where it becomes low-pressure refrigerant and in the ninth heat exchanger 9 where it absorbs heat from the inside air stream Fi,
the first refrigerant flow QR1″ and the second refrigerant flow QR2″ coming back together before returning to the compression device 15.
the dielectric heat transfer fluid circulates in the second two-fluid exchanger 2 where it gives up heat to the refrigerant, and splits into a first flow Q1″ circulating in the third heat exchanger 3 where it absorbs heat, and a second flow Q2″ circulating in succession in the fourth heat exchanger 4 where it absorbs heat and in the fifth heat exchanger 5 where it absorbs heat, the second flow Q2″ coming back together with the first flow Q1″.
the heat transfer liquid circulates in the first two-fluid exchanger 1 where it receives heat from the refrigerant, and circulates in the eighth heat exchanger 8 where it gives up heat to the outside air stream Fe.

This operating mode differs from the previous operating mode in that the refrigerant circulates in parallel in the second two-fluid exchanger 2 and in the ninth heat exchanger 9. The total flow of refrigerant is distributed between the first flow QR1″ and the second flow QR2″ by controlling the respective opening positions of the first expansion device 31 and the second expansion device 32.

Numerous other operating modes, not illustrated, are possible. For example, a passenger compartment air dehumidification mode is possible by circulating both a flow of refrigerant in the ninth exchanger 9 and a flow of heat transfer liquid in the seventh exchanger 7.

1. A thermal conditioning system for an electric or hybrid motor vehicle, comprising:
a refrigerant circuit comprising a main circulation loop comprising in succession, in a direction of circulation of the refrigerant:
a compression device,
a first two-fluid exchanger, arranged both on the main refrigerant loop and on a heat transfer liquid circuit so as to allow a heat exchange between the refrigerant and the heat transfer liquid,
a first expansion device,
a second two-fluid exchanger,
a dielectric heat transfer fluid circuit, comprising:
a primary circulation loop comprising in succession, in a direction of circulation of the dielectric heat transfer fluid:
the second two-fluid exchanger, arranged both on the main refrigerant loop and on the primary dielectric heat transfer fluid loop so as to allow a heat exchange between the refrigerant and the dielectric heat transfer fluid,
a third heat exchanger configured to be thermally coupled to a first element of an electric drive train of the vehicle,
a first bypass branch connected to the primary loop in parallel with the third heat exchanger, the first bypass branch comprising a fourth heat exchanger configured to be thermally coupled to a second element of the electric drive train of the vehicle and a fifth heat exchanger configured to be thermally coupled to a third element of the electric drive train of the vehicle,
a second bypass branch connected to the primary loop in parallel with the second two-fluid exchanger, the second bypass branch comprising a sixth heat exchanger configured to exchange heat with an air stream outside a passenger compartment of the vehicle.

2. The thermal conditioning system as claimed in claim 1, wherein the heat transfer liquid circuit comprises a primary circulation loop comprising in succession, in a direction of circulation of the heat transfer liquid:
the first two-fluid exchanger, arranged both on the main refrigerant loop and on the primary heat transfer liquid circulation loop so as to allow a heat exchange between the refrigerant and the heat transfer liquid,
a seventh heat exchanger configured to exchange heat with an air stream inside the passenger compartment of the vehicle.

3. The thermal conditioning system as claimed in claim 1, wherein the heat transfer liquid circuit comprises:
a bypass branch connected to the primary loop in parallel with the first two-fluid exchanger,
the bypass branch comprising an eighth heat exchanger configured to exchange heat with an air stream outside the passenger compartment of the vehicle.

4. The thermal conditioning system as claimed in claim 1, wherein the refrigerant circuit comprises:
a bypass branch positioned in parallel with the first expansion device and the second two-fluid exchanger,
the bypass branch comprises in succession a second expansion device and a ninth heat exchanger configured to exchange heat with an air stream inside the passenger compartment of the vehicle.

5. The thermal conditioning system as claimed in claim 1, wherein the primary loop of the dielectric heat transfer fluid circuit comprises a first circulation pump.

6. The thermal conditioning system as claimed in claim 1, wherein the primary loop of the heat transfer liquid circuit comprises a second circulation pump.

7. The thermal conditioning system as claimed in claim 1, wherein the primary loop of the dielectric heat transfer fluid circuit comprises a third circulation pump configured to take the dielectric heat transfer fluid from the third heat exchanger to the sixth heat exchanger without passing through the second two-fluid exchanger.

8. The thermal conditioning system as claimed in claim 1, wherein the main refrigerant loop comprises:
an internal heat exchanger comprises:
a first heat exchange section positioned downstream of the first two-fluid exchanger and upstream of the second two-fluid exchanger, and
a second heat exchange section positioned downstream of the second two-fluid exchanger and upstream of the compression device,
the internal heat exchanger being configured to allow a heat exchange between the refrigerant in the first heat exchange section and the refrigerant in the second heat exchange section.

9. The thermal conditioning system as claimed in claim 3, wherein the dielectric heat transfer fluid circuit comprises:
first three-way valve positioned both on the primary loop and on the first bypass branch, and
a second three-way valve positioned both on the primary loop and on the second bypass branch, and
wherein the heat transfer liquid circuit comprises a third three-way valve positioned both on the primary loop and on the bypass branch.

10. A method of operation of a thermal conditioning system as claimed in claim 2, in a passenger compartment heating mode, wherein:
the refrigerant circulates in the compression device where it becomes high-pressure refrigerant, and circulates in succession in the first two-fluid exchanger where it gives up heat to the heat transfer liquid, in the first expansion device where it becomes low-pressure refrigerant, and in the second two-fluid exchanger where it absorbs heat from the dielectric heat transfer fluid, and returns to the compression device,
the dielectric heat transfer fluid circulates in the second two-fluid exchanger where it gives up heat to the refrigerant, and splits into:
a first flow circulating in the primary loop, and
a second flow circulating in the second bypass branch, the second flow circulating in the sixth heat exchanger where it absorbs heat from the outside air stream,
the first flow splitting into a third flow circulating in the third heat exchanger where it absorbs heat, and
a fourth flow circulating in succession in the fourth heat exchanger where it absorbs heat, and in the fifth heat exchanger where it absorbs heat,
the third flow and the fourth flow coming back together with each other and then coming back together with the second flow,
the heat transfer liquid circulates in the first two-fluid exchanger where it receives heat from the refrigerant, and circulates in the seventh heat exchanger where it gives up heat to the inside air stream.
